(19) United States
(12) Patent Application Publication
(10) Pub. No.: US 2010/0182445 A1
(43) Pub. Date: Jul. 22, 2010

(54) Processing Device, Method, And Electronic System Utilizing The Same

(75) Inventor: Lita Chiang, Taipei (TW)

Correspondence Address: Wang Law Firm, Inc., 4989 Peachtree Parkway,, Suite 200, Norcross, GA, 30092, US

(73) Assignee: uPI Semiconductor Corporation, Taipai (TW)

(21) Appl. No.: 12/358,226

(22) Filed: Jan. 22, 2009

(51) Int. Cl. H04N 5/228; H04N 7/00

(52) U.S. Cl. 348/222.1; 348/E07.001; 348/552; 348/E05.091

(57) ABSTRACT

A processing device including a first camera and a control unit is disclosed. The first camera captures a first image. The control unit activates an appliance to execute a specific action according to the first image.

### BACKGROUND OF THE INVENTION

1. Field of the Invention

The invention relates to a processing device, and more particularly to a processing device that controls an appliance according to an external state.

2. Description of the Related Art

With technological development, functions and types of electronic appliances have increased. Generally, a user presses the button of an electronic appliance to control the electronic appliance. For example, an electronic appliance may comprise a power button. When the user presses the power button, the electronic appliance is turned on. When the user again presses the power button, the electronic appliance is turned off. However, the electronic appliance can not automatically provide its functions according to an external state.

### BRIEF SUMMARY OF THE INVENTION

Processing devices are provided. An exemplary embodiment of a processing device comprises a first camera and a control unit. The first camera captures a first image. The control unit activates an appliance to execute a specific action according to the first image.

A processing method is also provided. An exemplary embodiment of a processing method is described in the following. A first image is captured. The first image is processed. The processed first image is utilized to activate an appliance such that the appliance executes a specific action.

Electronic systems are also provided. An exemplary embodiment of an electronic system comprises an appliance and a processing device. The processing device comprises a first camera and a control unit. The first camera captures a first image. The control unit activates an appliance to execute a specific action according to the first image.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an electronic system;

FIG. 2 is a schematic diagram of another exemplary embodiment of the processing device;

FIG. 3 is a flowchart of an exemplary embodiment of a processing method; and

FIG. 4 is a flowchart of another exemplary embodiment of the processing method.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

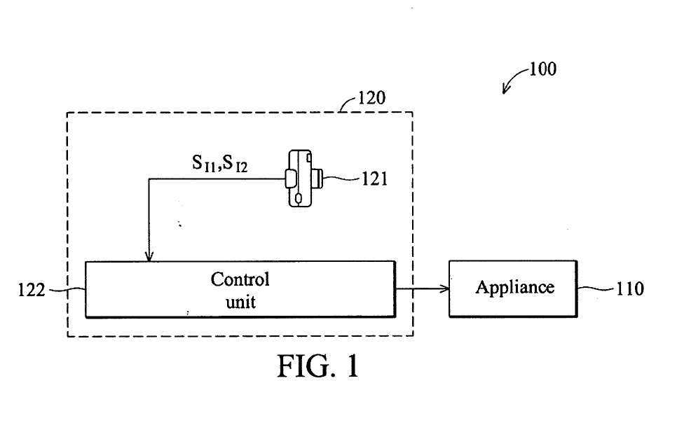

FIG. 1 is a schematic diagram of an exemplary embodiment of an electronic system. The electronic system 100 comprises an appliance 110 and a processing device 120. The appliance 110 may be a television, an air-conditioner, an electronic lamp, or other electronic products, but the disclosure is not limited thereto. In this embodiment, the processing device 120 and the appliance 110 are independent. In other embodiments, the processing device 120 is integrated with the appliance 110. Additionally, when the appliance 110 is activated, the processing device 120 starts operating.

As shown in FIG. 1, the processing device 120 comprises a camera 121 and a control unit 122. The camera 121 captures images S₁₁ and S₁₂. In this embodiment, the images S₁₁ and S₁₂ physically approach the appliance 110. The camera 121 utilizes the same focal length to capture images S₁₁ and S₁₂. The images S₁₁ and S₁₂ are the same or are different.

The control unit 122 activates the appliance 110 to execute a specific action according to the images S₁₁ and S₁₂. For example, the control unit 122 compares the images S₁₁ and S₁₂ to determine whether the images S₁₁ and S₁₂ are the same. If an object, such as a person, enters the camera shooting range of the camera 121, the image S₁₁ may be different from the image S₁₂. If no object enters the camera shooting range of the camera 121, the image S₁₁ may be the same as the image S₁₂.

In one embodiment, the control unit 122 only utilizes the first image S₁₁ to determine whether a human face exists in the image S₁₁. When the human face does not exist in the image S₁₁, it is determined that a user is not physically approaching the appliance 110. Thus, the appliance 110 executes a turn-off action. In one embodiment, the appliance 110 executes the turn-off action after a period. In another embodiment, the appliance 110 executes the turn-off action when the camera 121 captures at least one new image again. When the human face exists in the image S₁₁, it is determined that a user is physically approaching the appliance 110. Thus, the appliance 110 executes a turn-on action.

In addition, the control unit 122 determines the distance between the appliance 110 and the object (e.g. a user) according to the size of the human face. When the size of the human face exceeds a preset value, it is determined that the user very approaches the appliance 110 area, such as a television. Thus, the appliance 110 executes a turn-off action.

For example, if the appliance 110 is a television, when the distance between the cameras and an object, such as a child, is less than a threshold, it is determined that the child is too close to the TV. To protect the vision of child, the appliance 110 executes a turn-off action. If the appliance 110 is an air-conditioner, when the distance between the cameras and an object, such as a person, is increased, the appliance 110 increases wind force. When the distance between the cameras and the object exceeds a preset distance value, it is determined that the object has left the air-conditioning area. Thus, the air-conditioner executes a turn-off action.

In one embodiment, the image S₁₁ is served as a background model. The control unit 122 compares the background model and the image S₁₂. The control unit 122 activates the appliance 110 to execute a specific action according to the result of comparing the background model and the image S₁₂. For example, the comparing result may be the differences between the background model and the image S₁₂ pixels by pixels but the disclosure is not limited thereto. If the image S₁₂ is substantially different from the background model, the minus result may comprise various different pixels. If the number of the different pixels exceeds a preset value, it is determined that an object occurs in the image S₁₂ and the appliance 110 executes a specific action. If the number of the different pixels is less than the preset value, it is determined that no object occurs in the image S₁₂ and the appliance 110 does not execute the specific action.

In one embodiment, a connected component labeling algorithm is utilized for grouping the different pixels to generate an object region. If the size of the object region exceeds a first threshold value, it is determined that an object occurs in the image S₁₂. If the size of the object region is less than the threshold value, it is determined that the object region is caused by noise. Thus, the appliance 110 does not execute the specific action. Furthermore, if the size of the object region exceeds a second threshold value higher than the first threshold value, it is determined that an object approaches the appliance 110 (e.g. a television). Thus, the appliance 110 executes a turn-off action.

In other embodiments, the camera 121 continuously captures various images. The images are averaged and the averaged result is served as a background model. Then, the camera 121 captures a new image. The current image is compared with the background model to detect an object. In the averaged result, the object is unobvious because backgrounds (e.g. furnitures or electric appliances) continuously occur and the object does not continuously occur. In other embodiments, the background model can be established by different methods.

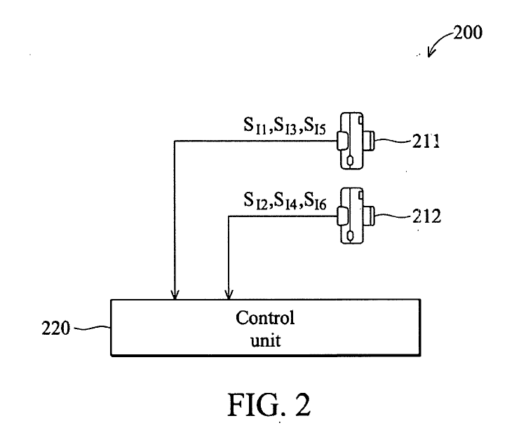

FIG. 2 is a schematic diagram of another exemplary embodiment of the processing device. The processing device 200 comprises cameras 211, 212, and a control unit 220. The camera 211 captures image S₁₁, meanwhile, the camera 212 captures image S₁₂. The camera 211 captures image S₁₃, meanwhile, the camera 212 captures image S₁₄. In this embodiment, the focal length of the camera 211 is the same as that of the camera 212.

The control unit 220 executes a specific action according to the image S₁₁-S₁₄. In one embodiment, the control unit 220 compares the images S₁₁ and S₁₂ to determine a first depth map and compares the images S₁₃ and S₁₄ to determine a second depth map. The first and the second depth maps can be generated by the stereo matching algorithm from the pair images that were captured at the same time. Then, the control unit 220 compares the first and the second depth maps and generates a compared result. In this case, the control unit 220 executes a specific action according to the result of comparing the first and the second depth maps. At this time, the first depth map that generated from pair images S₁₁ and S₁₂ is served as a background depth map.

In other embodiments, the control unit 220 averages the first and the second depth maps, but the disclosure is not limited thereto. The averaged result is served as a background depth map. In this case, the cameras 211 and 212 capture new images (e.g. S₁₅ and S₁₆). The control unit 220 compares the images S₁₅ and S₁₆ to determine a third depth map and then executes a specific action according to the background depth map and the third depth map. In some embodiments, the control unit 220 averages continuously various depth maps to generate the background depth map.

For example, the specific action is controlling the direction or the force of wind generated by the air-conditioner. In one embodiment, the control unit 220 determines the distance between an object and the cameras. In some embodiments, if the cameras are integrated with the appliance 110, when the distance between an object and the cameras is changed, the control unit 220 activates the appliance 110 to execute a specific action according to the kind of the appliance 110.

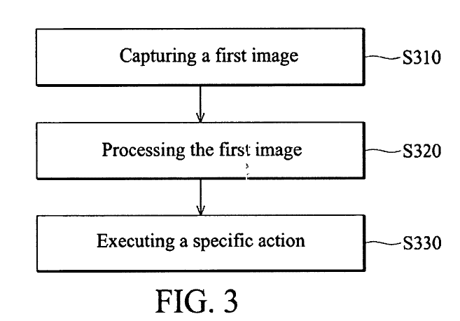

FIG. 3 is a flowchart of an exemplary embodiment of a processing method. A first image is captured (step S310). In this embodiment, the first image is captured by a first capturing device, such as camera. The first image is processed (step S320). According to the first image, a specific action for an appliance is executed (step S330). In this embodiment, the first image is utilized to determine whether a human face exists in the first image.

Assuming that the first capturing device approaches the appliance. When the human face does not exist in the first image, it is determined that a user is not physically approaching the appliance. Thus, the appliance executes a turn-off action. In one embodiment, the appliance executes the turn-off action after a period. In another embodiment, the appliance executes the turn-off action when the first capturing device captures at least one new image again. When the human face exists in the first image, it is determined that a user is physically approaching the appliance. Thus, the appliance executes a turn-on action.

In some embodiment, a second image is captured by the first capturing device. In this case, the first capturing device utilizes the same focal length to capture the first and the second images. The first and the second images are the same or different. The first and the second images are compared and the first image is served as a background model. For example, when an object enters the camera shooting range of the first capturing device, the first image may be the same as the second image. If no object enters the camera shooting range of the first capturing device, the first image may be different from the second image.

In other embodiments, various images are continuously captured. The captured images are averaged and the averaged result is served as a background model. Then, a new image is captured. The new image is compared with the background model to detect an object. In the averaged result, the object is unobvious because backgrounds (e.g. furnitures or electric appliances) continuously occur and the object does not continuously occur. In other embodiments, the background model can be established by different method.

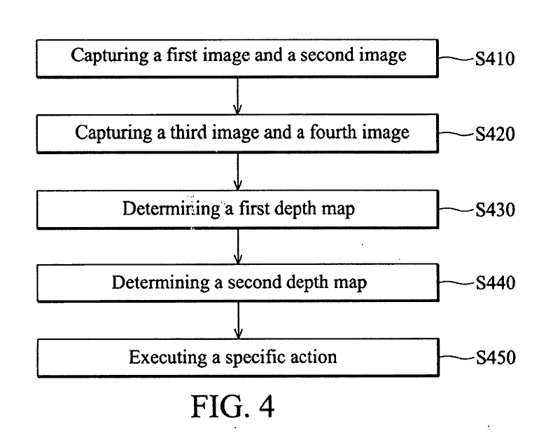

FIG. 4 is a flowchart of another exemplary embodiment of the processing method. A first image and a second image are captured (step S410). In one embodiment, the first and the second images are captured by a first capturing device. The first capturing device utilizes the same focal length to capture the first and the second images.

A third image and a fourth image are captured (step S420). In one embodiment, the third and the fourth images are captured by a second capturing device. The second capturing device utilizes the same focal length to capture the third and the fourth images. Additionally, the focal length of the second capturing device is the same as that of the first capturing device. The first capturing device captures the first image, meanwhile, the second capturing device the third image. The first capturing device captures the second image, meanwhile, the capturing device captures the fourth image.

The first and the third images are processed to determine a first depth map (step S430). The second and the fourth images are processed to determine a second depth map (step S440).

A specific action is executed according to the first and the second depth maps (step S450). In one embodiment, the first depth map is served as a background depth map. If a difference exists between the background depth map and the second depth map, an appliance executes a turn-on action referred to as the specific action.

In other embodiments, the continuous depth maps (e.g. the first and the second depth maps) can establish a background depth map. The background depth map can be established by different methods. For example, the continuous depth maps are averaged. The averaged result is served as a background depth map. In some embodiment, if a third depth map is determined according to a fifth image and a sixth image, the specific action is executed according to the result of comparing the background depth map and the third depth map. In this embodiment, the fifth image is captured by the first capturing device and the sixth image is captured by the second capturing device. In other embodiments, continuous images are captured to generate various depth maps. The continuously various depth maps are averaged to generate the background depth map.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A processing device, comprising:
a first camera capturing a first-image; and
a control unit activating an appliance to execute a specific action according to the first image.

2. The processing device as claimed in claim 1, wherein the appliance is a television or an air-conditioner.

3. The processing device as claimed in claim 2, wherein the control unit utilizes the first image to determine whether a human face exists in the first image.

4. The processing device as claimed in claim 3, wherein the appliance executes a turn-on action when the human face exists in the first image.

5. The processing device as claimed in claim 4, wherein the appliance executes a turn-off action when the size of the human face exceeds a preset value.

6. The processing device as claimed in claim 4, wherein the appliance executes a turn-off action when the human face does not exist in the first image.

7. The processing device as claimed in claim 6, wherein the appliance executes the turn-off action after a period.

8. The processing device as claimed in claim 6, wherein the appliance executes the turn-off action when the first camera captures at least one new image again.

9. The processing device as claimed in claim 1, wherein the first camera further captures a second image, the first image is served as a background model, and the control unit compares the background model and the second image to execute the specific action.

10. The processing device as claimed in claim 9, wherein me control unit processes the first and the second images to define a background model, the first camera further captures a third image, and the control unit compares the background model and the third image to execute the specific action.

11. The processing device as claimed in claim 10, wherein the control unit averages the first and the second images to define the background model.

12. The processing device as claimed in claim 9, further comprising a second camera capturing a third image and a fourth image, wherein the control unit activates the appliance to execute the specific action according to the first, the second, the third, and the fourth images.

13. The processing device as claimed in claim 12, wherein the control unit compares the first and the third image to generate a first depth map served as a background depth map, compares the second and the fourth image to generate a second depth map, and compares the background depth map and the second depth map to execute the specific action.

14. The processing device as claimed in claim 12, wherein the control unit compares the first and the third image to generate a first depth map, compares the second and the fourth image to generate a second depth map, and averages the first and the second depth maps to define a background depth map.

15. The processing device as claimed in claim 14, wherein the first and the second camera further capture a fifth image and a sixth image, respectively, the control unit compares the fifth and the sixth images to generate a third depth map, and the control unit executes the specific action according to the background depth map and the third depth map.

16. The processing device as claimed in claim 12, wherein when the appliance is an air-conditioner, the control unit controls the direction or the force of wind generated by the air-conditioner, according to the first and the second depth maps.

17. An electronic system, comprising:
an appliance; and
a processing device, comprising:
a first camera capturing a first image; and
a control unit activating an appliance to execute a specific action according to the first image.

18. The electronic system as claimed in claim 17, wherein the appliance is a television or an air-conditioner.

19. The electronic system as claimed in claim 18, wherein the control unit utilizes the first image to determine whether a human face exists in the first image.

20. The electronic system as claimed in claim 19, wherein the appliance executes a turn-on action when the size of the human face exists in the first image.

21. The electronic system as claimed in claim 20, wherein the appliance executes a turn-off action when the size of the human face exceeds a preset value.

22. The electronic system as claimed in claim 20, wherein the appliance executes a turn-off action when the human face does not exist in the first image.

23. The electronic system as claimed in claim 22, wherein the appliance executes the turn-off action after a period.

24. The electronic system as claimed in claim 22, wherein the appliance executes the turn-off action when the first camera captures at least one new image again.

25. The electronic system as claimed in claim 17, wherein the first camera further captures a second image, the first image is served as a background model and the control unit compares the background model and the second image to execute the specific action.

26. The electronic system as claimed in claim 25, wherein the control unit processes the first and the second images to define a background model, the first camera further captures a third image, and the control unit compares the background model and the third image to execute the specific action.

27. The electronic system as claimed in claim 26, wherein the control unit averages the first and the second images to define the background model.

28. The electronic system as claimed in claim 25, further comprising a second camera capturing a third image and a fourth image, wherein the control unit activates the appliance to execute the specific action according to the first, the second, the third, and the fourth images.

29. The electronic system as claimed in claim 28, wherein the control unit compares the first and the third image to generate a first depth map served as a background depth map, compares the second and the fourth image to generate a second depth map, and compares the background depth map and the second depth map to execute the specific action.

30. The electronic system as claimed in claim 28, wherein the control unit compares the first and the third image to generate a first depth map, compares the second and the fourth image to generate a second depth map, and averages the first and the second depth maps to define a background depth map.

31. The electronic system as claimed in claim 30, wherein the first and the second camera further capture a fifth image and a sixth image, respectively, the control unit compares the fifth and the sixth images to generate a third depth map, and the control unit executes the specific action according to the background depth map and the third depth map.

32. The electronic system as claimed in claim 28, wherein when the appliance is an air-conditioner, the control unit controls the direction or the force of wind generated by the air-conditioner, according to the first and the second depth maps.

33. A processing method, comprising:
capturing a first image;
processing the first image; and
activating an appliance according to the processed result, wherein when the appliance is activated, a specific action is executed.

34. The processing method as claimed in claim 33, wherein the processing step is determining whether a human face exists in the first image.

35. The processing method as claimed in claim 34, wherein the appliance executes a turn-on action when the human face exists in the first image.

36. The processing method as claimed in claim 35, wherein the appliance executes a turn-off action when the size of the human face exceeds a preset value.

37. The processing method as claimed in claim 34, wherein the appliance executes a turn-off action when the human face does not exist in the first image.

38. The processing method as claimed in claim 33, further comprising:
capturing a second image, a third image and a fourth image;
comparing the first and the third image to obtain a first depth map;
comparing the second and the fourth image to obtain a second depth map; and
obtaining a background depth map according to the first and the second depth maps, wherein the first and the second image are captured by a first capturing device and the third and the fourth image are captured by a second capturing device.

39. The processing method as claimed in claim 38, further comprising:
capturing a fifth image and a sixth image, wherein the fifth image is captured by the first capturing device and the sixth image is captured by the second capturing device;
comparing the fifth and the sixth image to obtain a third depth map;
comparing the background depth map and the third depth map; and
activating the appliance according to the result of comparing the background depth map and the third depth map.

40. The processing method as claimed in claim 39, wherein the appliance executes a turn-on action when a difference exists between the background depth map and the third depth map.
